(19) United States
(12) Patent Application Publication
(10) Pub. No.: US 2024/0229961 A1
(43) Pub. Date: Jul. 11, 2024

(54) VACUUM VALVE FOR A VACUUM CONVEYING SYSTEM

(71) Applicant: VAT HOLDING AG, Haag (CH)

(72) Inventors: Hanspeter FREHNER, Sevelen (CH); Florian EHRNE, Frümsen (CH); Martin NETZER, Bludenz (AT)

(21) Appl. No.: 18/546,243

(22) PCT Filed: Feb. 16, 2022
(86) PCT No.: PCT/EP2022/053819

§ 371 Date: Aug. 11, 2023

(30) Foreign Application Priority Data
Feb. 19, 2021 (CH) 00162/21

(51) Int. Cl. F16K 31/06; B61B 13/10; B61B 13/12; F16K 31/04; F16K 31/08; F16K 31/122

(52) U.S. Cl. CPC F16K 31/0655; F16K 31/04; F16K 31/084; B61B 13/10; B61B 13/122; F16K 31/1221

(57) ABSTRACT

A valve for closing and opening a valve opening in a gas-tight manner and for ventilating a vacuum volume is disclosed. The valve includes a valve seat, a closure element and an adjusting unit, which is arranged to provide a movement of the closure element relative to the valve seat in such a way that the closure element is adjustable from an open position to a closed position and back again. The valve seat, the closure element and the adjusting unit are arranged in such a way that the closure element can be adjusted linearly along an opening axis. The valve comprises a holding device arranged to hold the closure element in the closed position by providing a holding force.

The invention relates to a device for ventilating a transport tube segment of a vacuum conveying system.

A vacuum conveying system as understood herein is in particular a high-speed transport system in which capsules or other vehicles travel at very high speed in a (largely) evacuated tube on a guide system, e.g. on a rail system, an air cushion or magnetically repelled sliding. In the vicinity of fixed stations, linear motors can enable high accelerations, as in a maglev train, while electrically driven compressors can generate sufficient propulsion when cruising speed is reached. Alternatively, a corresponding drive can be provided on the part of the object moving in the tube.

Such a vacuum conveying system has, for example, two adjacent transport tubes made of steel or another suitable material, e.g. a metal-like, metal-containing or concrete-like material (concrete). Preferably, at least a rough or fine vacuum prevalis in the transport tubes. The vacuum is intended to enable travel speeds up to above the speed of sound by the resulting reduction in air resistance within the transport tube. Capsules or vehicles with space for several passengers can be moved or loads transported in the tubes (e.g. cars).

The capsules or vehicles should be moved in a sliding manner with as little friction as possible. For this purpose, for example, the use of an electromagnetic levitation system is proposed.

For example, the capsules or vehicles can be made primarily of aluminum or alternative lightweight materials and have a diameter of at least two meters. Furthermore, an unladen weight of 3 to 3.5 metric tons is proposed, and a payload of between 12 and 25 metric tons may be provided.

The transport tubes can have an Inner diameter of slightly more than the capsule diameter and a wall thickness of at least 20 mm. The internal pressure can be maintained at, for example, about 100 Pascal (1 millibar). Support pillars carrying the transport tubes may be positioned with an average spacing of about 30 meters and may be secured against earthquakes by damping elements. It is understood that the transport tubes can also be constructed close to the ground or at least partially underground, for example by analogy with a subway, etc., or as tunnels.

A critical factor for the operation of such a vacuum conveying system is generally the management of a desired vacuum within the system, i.e. in particular the creation, maintenance and targeted release of the vacuum. Especially during an unloading or loading or a removal or an insertion of a transport vehicle into the transport tube, an optimized procedure for this is indicated for efficiency reasons.

Furthermore, the fulfillment of self-imposed or officially mandated minimum safety requirements can pose a further problem with regard to safe and reliable operation. In particular, the avoidance and prevention of possible hazards for persons and goods must be strived for, Particularly when transporting people but also, for example, dangerous goods, it is essential that the safety equipment provided enables people or goods to be recovered or evacuated from the transport tube without injury in an emergency. In the event of an emergency, the time factor—how quickly the transport tube can be evacuated—is particularly decisive.

Due to the negative pressure typically present in the transport tube during operation, at least partial ventilation of the tube may be required for emergency evacuation but also for normal loading and unloading. One problem associated with such ventilation, especially in an emergency, is that the ventilation must be fast, reliable and at the required location, i.e., for example, at a specific position along the transport tube.

It is therefore the object of the present invention to provide a device for a vacuum conveying system which reduces or avoids the above disadvantages.

In particular, it is an object of the invention to provide a ventilation concept that provides improved accessibility of the transport syster espe ally with regard to speed and reliability.

The above objects are solved by the realization of the characterizing features of the independent claims. Features which further form the invention in an alternative or advantageous manner are to be taken from the dependent claims.

The approach of the present invention to solving the above problems is based on a flood valve that allows rapid ventilating of an internal volume.

To solve the above problems, the integration of a plurality of separation devices (valves) along the transport tube is proposed in particular. With the help of such separation devices, on the one hand, certain station areas along the line can be atmospherically separated from the tube and ventilated and made accessible for loading and unloading. After the loading activity, the area is then closed off again, evacuated and the valves opened.

On the other hand, the separation devices can be provided at certain regular intervals along the route. This allows a certain section of the transport tube to be closed in an emergency and then ventilated so that a rescue of people and/or goods can be initiated.

At least one flood valve or a plurality of flood valves can be assigned to each separable section. After a tube section has been cut off, the relevant section can be ventilated by actuating the flood valve.

The invention relates to a valve, in particular a flood valve or vacuum flood valve, for closing and opening a valve opening in a gas-tight manner and for ventilating a vacuum volume, in particular for a vacuum conveying system with a transport tube for transporting an object inside along the transport tube. The valve has a valve seat, which in turn has the valve opening defining an opening axis and a first sealing surface. A closure element for substantially gas-tight closure of the valve opening is provided with a second sealing surface corresponding to the first sealing Surface, wherein the second sealing surface is in an opposing position relative to the first sealing surface. In particular, the first and/or the second sealing surface can have a sealing element (seal, sealing material). The sealing element is in particular vulcanized, glued or clamped.

The valve has an adjusting unit arranged to provide movement of the closure element relative to the valve seat such that the closure element is adjustable from an open position, in which the closure element at least partially clears the valve opening, into a closed position, in which the second sealing surface is pushed or pulled in the direction of the first sealing surface and the closure element closes the valve opening, and back again.

The valve seat, the closure element and the adjusting unit are arranged in such a way that the closure element is linearly adjustable along the opening axis. The valve has a holding device designed to hold the closure element in the closed position by providing a holding force.

In particular, the holding device is different from the adjusting unit, i.e. the holding force is not provided by the adjusting unit but by the holding device alone.

In particular, the valve is designed generically to ventilate a transport tube of a vacuum conveying system with comparatively low energy consumption and/or largely automatically. The ventilating can be initiated in particular in emergency situations solely by a corresponding control signal. For this purpose, the valve can be connected to an emergency power supply, for example, which provides sufficient energy to actuate the valve even in the event of a failure of a typical power supply. For this purpose, the holding device in particular is controlled and the holding force is reduced.

In one embodiment, the opening axis may be such that the first sealing surface faces in a direction parallel to the opening axis and the first sealing surface extends orthogonally to the opening axis. In particular, the closure element can extend in a plane orthogonally to the opening axis.

According to one embodiment, the valve may have a coupling element and the holding device may be arranged and configured to apply the holding force to the coupling element. The coupling element provides a connection or coupling of the closure element with the adjusting unit. The coupling element can be designed in particular as a valve rod, shaft or spindle and can be displaced and/or driven by means of the adjusting unit.

The coupling element thus connects the adjusting unit and the closure element and provides the mobility of the closure element by means of the adjusting unit, By means of the holding device, a holding force can be applied to the coupling element and thus the mobility can be restricted or blocked. For example, rotation or translation of the coupling element can be prevented. The closure element can thus be held in the closed position and/or in the open position.

In one embodiment, the holding device may be configured to generate the holding force between the closure element and the valve seat and/or between the closure element and the adjusting unit and/or between the closure element and a valve housing.

The holding device can be designed as an electromechanical brake, clamping device or electromagnet, in particular wherein the holding force can be provided in a currentless state of the holding device and can be reduced or released by energizing (applying a current to) the holding device.

Such a design allows the valve to be held in the closed position without having to apply a current to the valve. A current can then be applied to open the valve.

In one embodiment, the adjusting unit can be a solenoid or an electromechanical unit, in particular a motor, stepper motor or actuator.

The valve can also have an energy storage device, in particular a battery or an accumulator, wherein the energy storage device is set up to supply energy to the holding device and/or the adjusting unit and is connected to the holding device or the adjusting unit.

According to one embodiment, the valve may have a control unit for actuating the adjusting unit and/or the holding device.

The control unit can in particular have a closing functionality set up in such a way that, when it is executed, the closure element is moved into the closed position by means of controlled operation of the adjusting unit, after the closed position has been reached, the closure element is held in the closed position by providing the holding force by means of the holding device (by means of controlled operation of the holding device) and then the actuation of the adjusting unit and/or the holding device is terminated or the adjusting unit and/or the holding device is set to a standby mode or non-operation, wherein the holding force remains provided.

In particular, the control unit can have an opening functionality set up in such a way that, when it is executed in the closed position, the holding force is reduced or released by actuating the holding device, wherein the closure element is displaced from the closed position in the direction of the open position by an opening force (restoring force) acting on the closure element, and/or the adjusting unit is actuated in such a way that the closure element is displaced into the open position.

In one embodiment, the first and/or the second sealing surface may comprise a sealing material, and by contacting the sealing material through the first and the second sealing surface in the closed position, a gas-tight closure of the valve opening can be provided.

In particular, the first sealing surface surrounds the valve opening.

According to one embodiment, the closure element has a closure part and a compensation part, and a bypass channel connects the closure part and the compensation part. With such a design, a force to be applied by the adjusting unit or holding device to close or hold closed can be reduced. The design of the mechanical element is simplified accordingly.

In particular, the closure part can have a first vacuum side and a first atmosphere side opposite the first vacuum side, and the compensation part can have a second vacuum side and a second atmosphere side opposite the second vacuum side. The compensation part may thereby delimit a compensation volume, wherein the size of the compensation volume is variable depending on the position of the closure element along the opening axis. A pressure present in the compensation volume is in particular equal to a pressure present at the first vacuum side, in particular equal to a pressure present in the bypass channel,

In particular, the compensation volume can be limited by a housing of the valve and the compensation part, especially the second vacuum side. The size of the compensation volume is thus determined by the spatial extension of the limiting valve housing and a position of the compensation part of the adjustment element.

A surface area of the first vacuum side may be larger than a surface area of the second vacuum side.

In addition or alternatively, a projection of the first vacuum side onto a plane orthogonally to the opening axis may enclose a larger area than a projection of the second vacuum side onto this plane.

In addition or alternatively, a diameter and/or circumference of the closure part may be larger than a diameter and/or circumference of the compensation part.

In such a valve variant, the valve disk (closure element) can be pulled to the valve seat by means of a spindle. Subsequently, this position can be held by means of a brake (holding device), in particular without current. Instead of or in addition to the brake, a holding magnet can be provided.

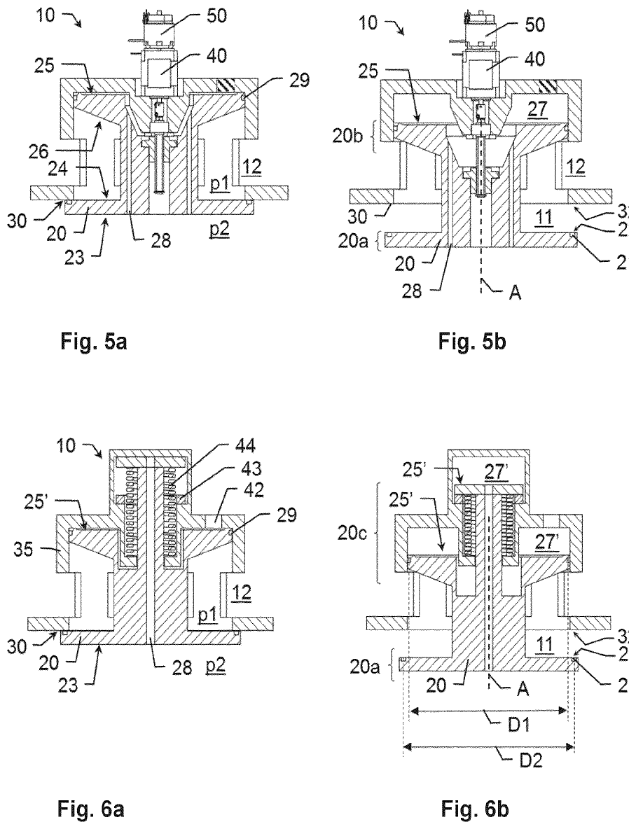

The force required for sealing results from a minimum pressing force with which the seal (sealing material) must be pressed between the valve seat and the valve disk and a (Δp) force resulting from a pressure difference (diameter and/or circumference of the closure part D2>diameter and/or circumference of the compensation part D1; see also FIGS. 5a and 5b).

The diameters D1 and D2 can be designed so that the difference between the two Surfaces, at a differential pressure of 1 bar (pressure on one of the vacuum sides relative to the surrounding atmospheric pressure), can open the disk when the brake is open.

To flood the system, this can be used to open the brake (current), wherein the differential pressure opens the valve.

The energy required to release the brake can be provided, for example, by a battery in the event of a power failure.

In one embodiment, the second sealing surface may be arranged on the closure part, in particular on the first atmospheric side, and the closure element may have a third sealing surface arranged on the compensation part and corresponding to and cooperating with a fourth sealing surface for limiting and sealing the compensation volume (see also FIGS. 5a and 5b).

The closure part and the compensation part can, in particular, be structurally firmly connected to one another, in particular be of integral design, wherein the closure part and the compensation part are moved simultaneously when the closure element is moved.

The invention also relates to a valve, in particular a flood valve or vacuum flood valve, for closing and opening a valve opening in a gas-tight manner and for ventilating a vacuum volume, in particular for a vacuum conveying system having a transport tube for transporting an object inside along the transport tube. The valve has a valve seat having the valve opening defining an opening axis and a first sealing surface. In addition, the valve has a closure element for the substantially gas-tight closure of the valve opening with a second sealing surface corresponding to the first sealing surface.

The closure element is arranged to be movable along the opening axis and relative to the valve seat in such a way that the closure element is adjustable from an open position, in which the closure element at least partially clears the valve opening, into a closed position, in which the second sealing surface is pressed or pulled in the direction of the first sealing surface and the closure element closes the valve opening, and back again. The second sealing surface is in an opposing position relative to the first sealing surface.

The valve also has a valve housing which at least partially encloses the closure element. The closure element has a closure part, in particular a valve disk, and an adjusting part. The closure part is designed for substantially gas-tight closure of the valve opening, and the second sealing surface is arranged on the closure part. The adjusting part delimits a displaced volume inside the valve housing, wherein a size of the displaced volume is variable as a function of a position of the closure element along the opening axis.

The vaive also has a lifting and holding unit designed and arranged to provide a lifting force (and/or holding force) for displacing and/or holding the closure element to or in the closed position. The lifting force can be understood as a holding force in a holding state (e.g. in the closed position).

In one embodiment, the valve may further comprise a control unit for actuating the lifting and holding unit.

In particular, the control unit can have a closing functionality set up in such a way that, when it is executed, the lifting force is provided by means of actuating the lifting and holding unit, the closure element is moved into the closed position on the basis of the lifting force, after the closed position has been reached, the closure element is held in the closed position by actuating the lifting and holding unit, and the actuation of the lifting and holding unit is terminated or the lifting and holding unit is moved into a standby mode or non-operation, wherein the lifting force or a holding force is provided.

In particular, the lifting and holding unit can have a lifting channel that can be closed and opened by means of a shut-off component, wherein the lifting channel provides a connection between the displaced volume and an external atmosphere. By generating a relative vacuum in the displaced volume (via the lifting channel), the closure element can be pulled into the closed position, thus closing the valve. When the closure element is in the closed position, the displaced volume can be atmospherically isolated, causing the closure element to remain in the closed position.

In one embodiment, the lifting and holding unit may comprise a first holding element, in particular an electromagnet or clamping mechanism, wherein the first holding element is configured and arranged to hold the closure element in the closed position.

Alternatively or additionally, the lifting and holding unit can have a second holding element, in particular an electromagnet or clamping mechanism, wherein the second holding element is designed and arranged to hold the closure element in the open position,

The lifting and holding unit can thus be designed and set up to hold the closure element in the open position and/or in the closed position.

According to one embodiment, the lifting and holding unit can have a restoring element, in particular a spring or compression spring. The restoring element is in particular coupled to the closure element and a restoring force causes the closure element to be pressed in a certain direction. The restoring element can cause such a restoring force (in terms of direction and amount) that the closure element is pressed into the closed position. Opening of the vaive can then be realized by overcoming the restoring force.

In one embodiment, the lifting and holding unit can have a vacuum generator for generating a vacuum or a relative negative pressure in the displaced volume or can be connected to such a vacuum generator. The vacuum generator can, for example, be designed as a vacuum pump or can have a vacuum bypass which can be shut off and opened in a controlled manner and which connects the vacuum volume and the displaced volume (cf. FIGS. 8a and 8b).

The vacuum generator may be connected to the displaced volume by a suction channel, in particular wherein the lifting channel itself provides or embodies the suction channel.

As already mentioned above, such an arrangement allows the valve to be closed solely by evacuating the displaced volume. The negative pressure thus created in the displaced volume moves the closure element into the closed position.

In particular, the valve may comprise a bypass channel, wherein the bypass channel provides a connection of the displaced volume and the vacuum volume (e.g., the interior of a transport tube of a vacuum conveying system).

According to one embodiment, the bypass channel may have a check valve, which check valve is closed when a lifting pressure present in the displaced volume is less than a vacuum pressure in the vacuum volume and is open when a lifting pressure present in the displaced volume is greater than a vacuum pressure in the vacuum volume. Such an arrangement can ensure that the pressure inside the closed displaced volume (I.e., the lifting channel is closed) always remains less than or equal to the pressure in the vacuum volume connected by the bypass.

The check valve thus ensures that the closure element remains in the closed position even if the pressure in the vacuum volume becomes lower than the pressure in the displaced volume (see FIGS. 8a and 8b).

In one embodiment, the closure part may have a first vacuum side and the adjusting part may have a second vacuum side bounding the displaced volume and facing the displaced volume.

According to one embodiment, a surface area of the first vacuum side may be smaller than a surface area of the second vacuum side.

In addition or alternatively, a projection of the first vacuum side onto a plane orthogonally to the opening axis may enclose a smaller area than a projection of the second vacuum side onto the plane.

In addition or alternatively, a diameter and/or circumference of the closure part. (D2) may be smaller than a diameter and/or circumference of the adjusting part (D1).

Due to this size ratio of the closing part to the adjusting part, i.e. due to the difference of the pressure-effective areas, a required compression force in the closed position for sealing the valve opening can be provided solely due to a pressure difference (vacuum volume and displaced volume vs. atmospheric ambient pressure), i.e. no mechanical or magnetic brake is required for the closure element.

The valve can be opened by opening the lifting channel, wherein a comparatively rapid increase in pressure occurs in the displaced volume and the closure element is pushed into the open position.

The closure part and the adjusting part are in particular structurally firmly connected to one another, in particular designed integrally, wherein the closure part and the adjusting part are moved simultaneously when the closure element is moved.

The invention further relates to a vacuum conveying system having a transport tube for transporting an object inside along the transport tube, wherein a negative pressure, in particular a vacuum, can be provided inside the transport tube relative to the surrounding atmosphere. The vacuum conveying system further comprises a vaive according to the invention integrated into the vacuum conveying system and/or connected to the transport tube as described above.

The valve seat is integrated into and/or arranged on a wall of the transport tube in such a way that, in the open position of the valve, the valve opening opens up a flow path between the interior of the transport tube and the surrounding atmosphere.

By means of the vaive, a controlled, fast and reliable ventilation of the transport tube can be provided if required (e.g. in an emergency situation).

The object movable in the transport tube can be a means of transport, in particular a capsule or a vehicle, wherein the means of transport is designed for transporting a person and/or goods.

The vacuum conveying system can accordingly have a tube diameter of several meters, in particular at least two meters. The vacuum conveying system may be formed by integrating the valve with an emergency system for ventilating a tunnel section. This arrangement may be further advantageous for inserting and removing objects into and out of the transport system.

The invention is not limited to use in a vacuum conveying system. In general, the use of the valve according to the invention is conceivable for all vacuum-related areas of application in which, in particular, controlled or rapid ventilating of the vacuum volume is relevant.

In one embodiment, the first sealing surface may face the interior of the transport tube, and/or the valve seat and/or the first sealing surface may be present within the interior of the transport tube.

The devices according to the invention are described in more detail below by means of concrete exemplary embodiments shown schematically in the drawings, purely by way of example, with further advantages of the invention also being discussed. Identical or similarly acting elements or components of different embodiments are referenced with the same reference signs, wherein the drawings show in detail:

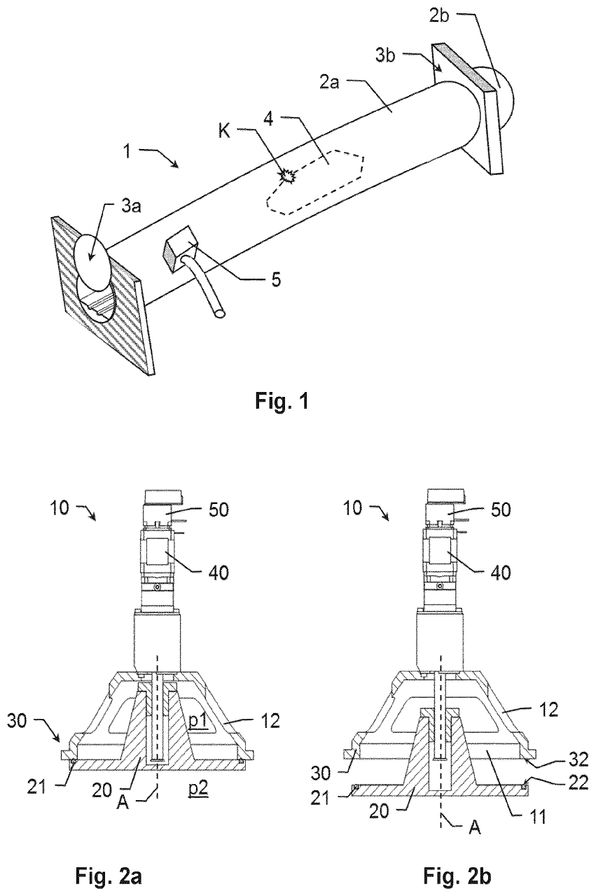

FIG. 1 shows an embodiment of a vacuum conveying system with a ventilating device for ventilating a transport tube of the vacuum conveying system as required;

FIGS. 2a-b show an embodiment of a valve according to the invention for ventilating a vacuum volume, in particular for closing and opening a valve opening in a gas-tight manner;

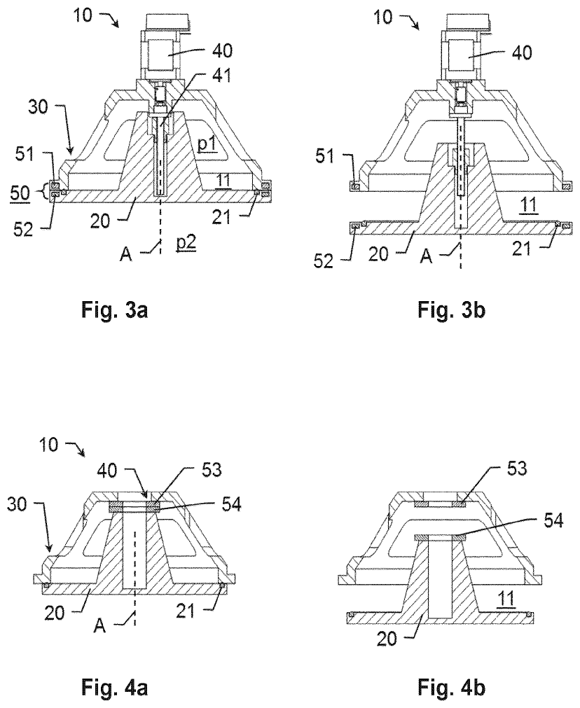

FIGS. 3a-b show a further embodiment of a valve according to the invention for ventilating a vacuum volume in the closed and open state;

FIGS. 4a-b show a further embodiment of a valve according to the invention for ventilating a vacuum volume in the closed and open state;

FIGS. 5a-b Show a further embodiment of a valve according to the invention for ventilating a vacuum volume in the closed and open state;

FIGS. 6a-b show a further embodiment of a valve according to the invention for ventilating a vacuum volume in the closed and open state;

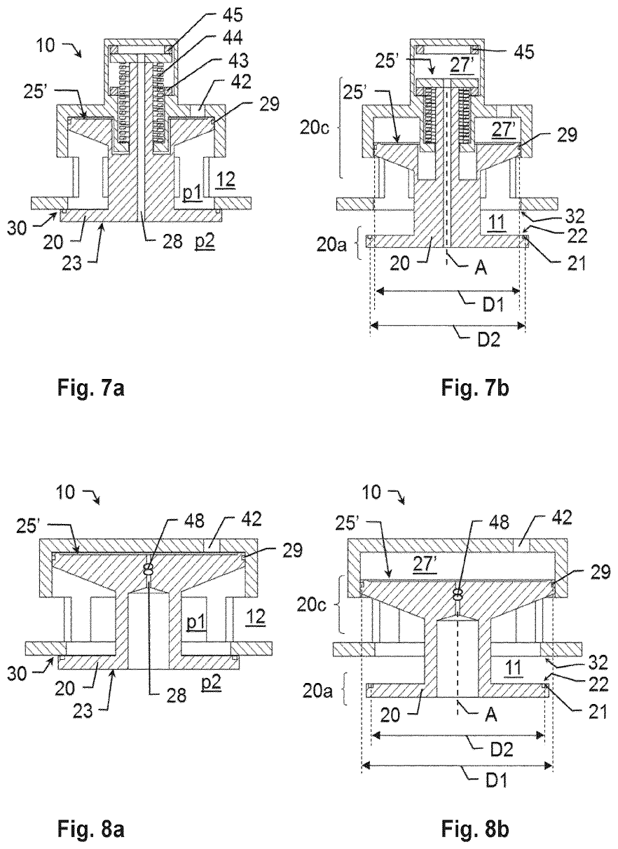

FIGS. 7a-b show a further embodiment of a valve according to the invention for ventilating a vacuum volume in the closed and open state; and

FIGS. 8a-b show a further embodiment of a vacuum valve according to the invention for closing an opening or sealing a volume.

FIG. 1 schematically shows a section of an exemplary transport tube 1 of a vacuum conveying system. The tube 1 is preferably composed of a plurality of tube segments (see 2a and 2b) which can be shut off from one another by vacuum valves (see 3a and 3b).

Flooding with air or equalizing pressure with the environment is relevant for safety reasons. For example, a vehicle 4 moving inside the transport tube 1 could experience a complication K such as a medical emergency, a leak in the vehicle housing, or a fire. In such an emergency situation, it is desired that the vehicle 4 stop as soon as possible. If the situation permits, the vehicle 4 could stop in a defined transport tube segment, or in any segment, in which case sensors are preferably present to detect the vehicle 4.

If the vehicle 4 comes to a stop in such a way that a valve cannot close, the next available valve can advantageously be accessed. Otherwise, a device could also be provided that moves the vehicle 4 in such a way that the valve area becomes free and the valve can close.

The vehicle 4 may be, for example, a capsule or a vehicle and may be configured to transport at least one person and/or goods.

The transport system also has a controller (not shown), in particular a computer, which can control two adjacent ones of the vacuum valves 3a and 3b in such a way that they close or open an inner volume of the intermediate transport tube segment 2a. A provided ventilating device 5 can then (after closing the segment 2a) be controlled, e.g. likewise by the controller, in order to lift by ventilating a vacuum or prevailing negative pressure prevailing in the inner volume of the intermediate transport tube segment 2a. For this purpose, the ventilating device 5 can have a valve (flood valve or vacuum flood valve) according to the invention or be designed as such a valve.

In particular, an unloading/reloading hatch is provided in some or all of the tube segments, for example, for a removal or insertion of the vehicle 4 (not shown).

For a vacuum conveying system, especially when transporting people, a critical factor when an emergency occurs is the time required to close a transport tube segment 2a and, in particular, to ventilate it. According to the invention, a valve, in particular a flood valve, is proposed for ventilating the transport tube, with which the process of ventilating can be carried out relatively very quickly and rellably.

FIGS. 2a and 2b show an embodiment of a valve 10 according to the invention for ventilating a vacuum volume, in particular for the gas-tight closing and opening of a valve opening 11. FIG. 2a shows the valve 10 in a closed state (closed position), FIG. 2b in an open state (open position).

The valve 10 has a valve seat 30 and a closure element 20. A valve opening 11 and an opening axis A are defined by the valve seat 30. A first sealing surface 32 of the valve seat 30 surrounds the valve opening 11. The closure element 20 has a second sealing surface 22 corresponding to the first sealing surface 32. An adjusting unit 40 is provided for moving the closure element 20.

The adjusting unit 40 may, for example, be designed as a motor, in particular an electric motor or stepper motor. The adjusting unit. 40 may further comprise a valve rod or a spindle, which is coupled to the closure element 20 and thereby provides a linear adjustability of the closure element 20 along the opening axis A. In the embodiment shown, a spindle or threaded rod is provided which is connected to a mating element (e.g., a corresponding internal thread) on the part of the closure element 20 and by rotation of which the linear movement of the closure element 20 can be generated. The adjusting unit 40 can alternatively be designed as a lifting magnet.

The valve 10 further comprises at least one inlet opening 12 connected to the valve opening 11 by a flow path. The flow path provides for the flow of a fluid through the valve 10 in the open position, wherein a flow direction is defined by an applied differential pressure.

The valve 10 is designed in such a way that the closure element 20 can be brought into the closed position by means of the motor 40. A seal 21 (sealing material, e.g. a polymer-containing, elastic material) which is arranged here on the side of the closure element 20 is pr ssed here between the first 32 and the second 22 sealing Surface. In another embodiment, the sealing material may be alternatively or additionally present on the part of the valve seat 30.

The valve 10 further comprises a holding device 50, which is arranged to hold the closure element 20 in the closed position by providing a holding force. The holding device 50 can be designed, for example, as an electromechanical brake with which the holding force can be exerted on a motor shaft, the valve rod or the spindle.

By means of the holding device 50, the closure element 20 can be held in the closed position. For this purpose, the brake 50 is brought into a braking position, for example, and thus the closure element 20 is held until the brake 50 is released, for example, by means of corresponding control of the holding device 50 after the closed position has been reached. An advantage of this embodiment is that, in order to provide the valve 10 in the closed position, no continuous or recurring operation of the motor 40 is required in order to permanently provide a minimum required pressing force (with which the first sealing surface is pressed onto the second sealing surface).

In addition, the holding device 50 can be designed in such a way that it can permanently provide the holding force without current being applied (currentless). The holding device 50 can thus provide the braking position without current being applied. To reduce or release the holding force, a current can be applied to the holding device 50 (energizing the holding device 50), whereby the brake opens and the closure element 20 can be moved from the closed position to the open position.

The adjusting unit 40 can be controlled accordingly for opening the valve 10. The adjusting unit 40 then actively moves the closure element 20 into the open position.

In an alternative embodiment, the opening of the valve 10 is provided and performed solely by a release of the brake 50 and an applied differential pressure. The differential pressure can be defined by an inlet-side pressure p1 (which can also be present in the valve housing) and a vacuum-side pressure p2 (which is present beyond the closure element 20 and, in the case of an arrangement with a vacuum conveying system, in the transport tube).

In this case, at least the minimum required pressing force and a differential pressure force a lied to the closure element by the differential pressure are provided in the closed position and permanently maintained by the holding device 50. Due to the differential pressure force, the valve 10 can be opened (alone) by loosening or releasing the brake (automatically).

The valve 10 may have an internal or separately connected energy storage device that can provide energy to the motor 50 and/or the brake 40 to allow the valve 10 to open despite failure in an emergency and in the event of a power failure, i.e., failure of the external power supply for the valve 10. The energy storage device holds at least the energy required to release the brake 50 magnetically switchable arrangement.

FIGS. 3a and 3b show a further embodiment of a valve 10 according to the invention for ventilating a vacuum volume, in particular for the gas-tight closing and opening of a valve opening 11. FIG. 3a shows the vaive 10 in a closed state (closed position), FIG. 3b in an open state (open position).

Corresponding to the embodiment of FIGS. 2a and 2b, a valve closure 20 (valve disk) is also coupled to a drive 40 here and can be moved linearly along the opening axis A by means of the drive 40. A sealing surface of the valve disk 20 has a sealing material 21 (e.g., O-ring or vulcanized (or molded on) polymer). In the closed state, the valve opening 11 is closed by contacting the sealing material 21 with the seat-side sealing surface and (simultaneously) the disk-side sealing surface.

The valve 10 has a holding device 50, which is arranged to hold the closure element 20 in the closed position by providing a holding force. The holding device 50 is designed as a magnetic holding device and has a first holding element. 51 and a second holding element 52. At least one of the two holding elements 51, 52 is designed as an electromagnet which provides a magnetic field as a function of an applied current. This and/or the other holding element 51, 52 can also have a permanent magnet.

It is understood that alternatively an embodiment with a holding device is also conceivable, which has only one of the two holding elements 51 or 52 (not shown).

In particular, the holding device 50 is configured such that the holding force between the valve closure element 20 and the valve seat 30 is provided without a current applied to the electromagnet (e.g., by a permanent magnet). With the application of a current to the electromagnet, the holding force is reduced or dissipated and the valve closure element 20 can leave the closed position due to its own weight and/or due to an applied differential pressure (p1>p2). The valve 10 can thus be opened by energizing one of the holding elements 51 or 52 alone (FIG. 3b).

By applying a current to the holding element formed as an electromagnet, a field can be generated which counteracts a magnetic field of a provided permanent magnet. Alternatively, applying the current can generate such a magnetic field that. the other (counter) holding element 51, 52 is repelled.

In an alternative embodiment (not shown), the valve 10 may alternatively or additionally have a brake unit designed as a holding element. The brake unit can be coupled to the motor or integrated into it.

To close the valve 10, the disk 20 is pulled to the seat 30 either by means of a motor and a spindle 41 as shown here or by means of a solenoid. A comparatively small force is required for this stroke (corresponding to the mass of the disk 20). In the closed position thus reached, the plate 20 is held by means of the holding device 50 (e.g. without current). The holding force provided corresponds to at least a minimum pressing force plus a force present due to a differential pressure (p1>p2).

In this state, a volume connected to the valve (e.g. transport tube of a vacuum conveying system) can be evacuated, i.e. the pressure p2 can be reduced.

To flood the volume or open the valve 10, the solenoid is energized, thereby reducing or dissipating the holding force. Due to the prevailing differential pressure, the valve 10 is then opened. In particular, the valve 10 has a battery for emergency opening in the event of a power failure.

FIGS. 4a and 4b show a further embodiment of a valve 10 according to the invention for ventilating a vacuum volume, in particular for the gas-tight closing and opening of a valve opening 11. FIG. 4a shows the valve 10 in a closed state (closed position), FIG. 4b in an open state (open position).

In contrast to the embodiment according to FIGS. 3a and 3b, the vaive 10 here has a magnetically switchable arrangement as an adjusting unit. 40, which at the same time provides the function of a holding device and is thus also to be regarded as such.

The magnetically switchable arrangement has a first element 53 arranged on the inside of the valve housing and a second element 54 arranged on the closure element 20 and interacting attractively with the first element 53 depending on a circuit (e.g., applied current or no current). In particular, the circuitry can provide or turn off a magnetic force that acts between the first element 53 and the second element 54 and attracts both elements,

At least one of the two elements 53, 54 can be designed in such a way that the controllably generated magnetic force causes the closure element 20 to move from the open position (FIG. 4b) to the closed position (FIG. 4a). In particular, the valve 10 has a drive unit (not shown), wherein the valve disk 20 is coupled to the drive 40 and can thus be moved linearly along the opening axis A into the closed position and into the open position. In the closed position, a holding force can be provided by the magnetically switchable arrangement. The drive unit can be de-energized in this case.

The adjusting unit or holding device can be designed so that the attracting magnetic force is provided in a currentless state and is reduced or dissipated by applying a current. Alternatively, the design may provide the magnetic force when current is applied and no magnetic force is generated in a currentless state. Holding and releasing the shutter element 20 in the closed position may be accomplished by corresponding switching of the two elements 53, 54.

FIGS. 5a and 5b show a further embodiment of a valve 10 according to the invention for ventilating a vacuum volume, in particular for the gas-tight closing and opening of a valve opening 11. FIG. 5a shows the vaive 10 in a closed state (closed position), FIG. 5b in an open state (open position).

The valve 10 has a valve seat 30 and a closure element 20. A valve opening 11 and an opening axis A are defined by the valve seat 30. A first sealing surface 32 of the valve seat 30 surrounds the valve opening 11. The closure element 20 has a second sealing surface 22 corresponding to the first sealing surface 32. An adjusting unit 40 is provided for moving the closure element 20 along the opening axis A.

The adjusting unit 40 may, for example, take the form of a motor, in particular an electric motor or stepper motor. The adjusting unit. 40 may further comprise a valve rod or a spindle which is coupled to the closure element 20 and thereby provides a linear adjustability of the closure element 20 along the opening axis A. In the embodiment shown, a spindle is provided which is connected to a mating element (e.g., a corresponding internal thread) on the side of the closure element 20 and by rotation of which the linear movement of the closure element. 20 can be generated. The adjusting unit 40 can alternatively be designed as a lifting magnet.

The valve 10 further comprises at least one inlet opening 12 connected to the valve opening 11 by a flow path. The flow path provides for the flow of a fluid through the valve 10 in the open position, wherein a flow direction is defined by an applied differential pressure.

The valve 10 is designed in such a way that the closure element 20 can be brought into the closed position by means of the motor 40. A seal 21 (sealing material, e.g. a polymer-containing, elastic material) which is arranged here on the side of the closure element 20 is pressed here between the first 32 and the second 22 sealing Surface. In another embodiment, the sealing material may be alternatively or additionally present on the part of the valve seat 30.

The valve 10 further comprises a holding device 50, which is arranged to hold the closure element 20 in the closed position by providing a holding force. The holding device 50 can be designed, for example, as an electromechanical brake with which the holding force can be exerted on a motor shaft, the valve rod or the spindle.

By means of the holding device 50, the closure element 20 can be held in the closed position. For this purpose, the brake 50 is brought into a braking position, for example, and thus the closure element 20 is held until the brake 50 is released, for example, by means of corresponding control of the holding device 50 after the closed position has been reached. An advantage of this embodiment is that, in order to provide the valve 10 in the closed position, no continuous or recurring operation of the motor 40 is required in order to permanently provide a minimum required pressing force (with which the first sealing surface is pressed onto the second sealing surface).

In addition, the holding device 50 can be designed in such a way that it can permanently provide the holding force without current being applied (currentless). The holding device 50 can thus provide the braking position without current being applied. To reduce or release the holding force, a current can be applied to the holding device 50 (energizing the holding device 50), whereby the brake opens and the closure element 20 can be moved from the closed position to the open position.

The adjusting unit 40 can be controlled accordingly for opening the valve 10. The adjusting unit. 40 then actively moves the closure element 20 into the open position.

In an alternative embodiment, the opening of the valve 10 is provided and performed solely by a release of the brake 50 and an applied differential pressure. The differential pressure can be defined by an inlet-side pressure p1 (which can also be present in the valve housing) and a vacuum-side pressure p2 (which is present beyond the closure element 20 and, in the case of an arrangement with a vacuum conveying system, in the transport tube).

In this case, at least the minimum required pressing force and a differential pressure force applied to the closure element by the differential pressure are provided in the closed position and permanently maintained by the holding device 50. Due to the differential pressure force, the vaive 10 can be opened (alone) by loosening or releasing the brake (automatically).

The vaive 10 may have an internal or separately connected energy storage device that can provide energy to the motor 50 and/or the brake 40 to allow the valve 10 to open despite failure in an emergency and in the event of a power failure, i.e., failure of the external power supply for the valve 10. The energy storage device holds at least the energy required to release the brake 50.

The valve 10 also includes a channel 28 connecting a closure part 20a and a compensation part 20b of the closure element.

The closure part 20a has a first vacuum side 23 and a first atmosphere side 24 opposite the first vacuum side, wherein the compensation part 20b has a second vacuum side 25 and a second atmospher side 26 opposite the second vacuum side. The compensation part 20b, together with the housing of the valve 10, delimits a compensation volume 27. The size of the compensation volume 27 depends on the position of the closure element 20. The compensation volume 27 is sealed off from the outer atmosphere by means of a seal 29.

Due to the connection provided by the channel 28, a pressure present in the compensation volume 27 is equal to a pressure present at the first vacuum side 23. A free fluid exchange can take place between the compensation volume 27 and the first vacuum side 23 as a function of a pressure difference for pressure compensation.

The surface area of the first vacuum side 23 is larger than the surface area of the second vacuum side 25. In particular, a projection of the first vacuum side 23 onto a plane orthogonal to the opening axis A has a larger surface area than a projection of the second vacuum side 25 onto this plane. In particular, a diameter and/or circumference of the closure part 20a is larger than a diameter and/or circumference of the compensation part 20b. Due to said different sizes, opening is ensured solely due to a pressure difference p1>p2.

The compensation volume 27 together with the channel 28, which connects the compensation volume 27 with the vacuum inside the transport tube when the valve 10 is used generically with and on a vacuum conveying system, together with the geometric size ratios of the closure part 20a and the compensation part 20b, cause a comparatively small force to be applied to the valve in the closed state due to the pressure difference p1>p2. To hold the valve 10 in the closed position, therefore, only this small force needs to be counteracted and a minimum pressing force generated.

FIGS. 6a and 6b show a further embodiment of a valve 10 according to the invention for ventilating a vacuum volume, in particular for the gas-tight closing and opening of a valve opening 11. FIG. 6a shows the valve 10 in a closed state (closed position), FIG. 6b in an open state (open position).

The valve 10 has a valve seat 30 and a closure element 20. A valve opening 11 and an opening axis A are defined by the valve seat 30. A first sealing surface 32 of the valve seat 30 surrounds the valve opening 11. The closure element 20 has a second sealing surface 22 corresponding to the first sealing surface 32.

The valve 10 further comprises at least one inlet opening 12 connected to the valve opening 11 by a flow path. The flow path provides for the flow of a fluid through the valve 10 in the open position, wherein a flow direction is defined by an applied differential pressure (p1/p2).

The valve 10 further comprises a bypass channel 28 connecting a closure part. 20a and an adjusting part 20c of the closure element 20. The adjusting part 20c delimits a displaced volume 27′ inside the valve housing, wherein a size of the displaced volume 27′ is variable depending on a position of the closure element 20 along the opening axis A.

The closure part 20a has a first vacuum side 23, with the adjusting part 20c having a second vacuum side 25′. The adjusting part 20c together with the housing of the valve 10 delimits the displaced volume 27′. The displaced volume 27′ is sealed off from the external atmosphere by means of a seal 29.

The valve 10 further comprises a lifting and holding unit designed and arranged to provide a lifting force for displacing and/or holding the closure element 20 into or in the closed position. The lifting and holding unit has a compression spring 44 and a lifting channel 42 which can be closed and opened by means of a shut-off component (e.g. valve), wherein the lifting channel 42 provides a connection between the displaced volume 27′ and an external atmosphere.

The lifting and holding unit also has a holding element 43, designed here as an electromagnet, with the holding element 43 being designed and arranged to hold the closure element 20 in the open position.

The displacement of the valve 10 from the open position (FIG. 6b) to the closed position (FIG. 6a) is essentially effected by a corresponding control of the lifting and holding unit. In the open position, a portion of the second vacuum side 25′ is held in the lower position shown by the holding element 43. When the shut-off component is open and thus the lifting channel 42 is open, a holding force caused by the holding element 43 can be reduced or switched off. The shut-off component can alternatively be closed, whereby a flow of fluid present in the displaced volume 27′ can occur via the channel 28. Due to the missing or reduced holding force, the closure element 20 is moved into the closed position by means of the compression spring 44 and the valve opening 11 is closed.

In this position, the shut-off component—if not already present in this state—is then closed (also by appropriate control). The lifting channel 42 is closed.

After closing the lifting channel 42, a volume facing the first vacuum side 23 can be evacuated. This also reduces the pressure inside the displaced volume 27′ accordingly.

The total surface of the first vacuum side 23 is larger than the total surface of the second vacuum side 25′. This means that a projection of the first vacuum side 23 onto a plane orthogonal to the opening axis A has here, within a boundary line defined by the seal 21 and also projected, a larger surface area than a projection of the second vacuum side 25′ onto this plane, which is bounded by a boundary line defined by the seal 29 and also projected. As shown here accordingly, the diameter

Di is smaller than the diameter D2. In particular, a diameter and/or circumference of the closure part 20a is larger than a diameter and/or circumference of the adjusting part 20c.

The said different diameters D1 and D2 are selected in such a way that the tensile force applied to the closure element 20 in the direction of the open position by the differential pressure p1>p2 is only so great that the closure element 20 can be moved into the open position when the displaced volume 27′ is vented. In addition, the design (D1 to D2) can significantly reduce the holding force required to hold the valve 10 in the closed position, so that the compression spring can be designed solely to compensate for the tensile force and a minimum compression force. The differential pressure in this closed position acts with respect to the area within the diameter difference D2-D1.

To open the valve 10, the displaced volume 27′ is vented, i.e. the shut-off component is controlled in such a way that the lifting channel 42 is opened and a fluid (e.g. air) with e.g. a ssure p1 flows from outside into the displaced volume 27′. This increases the differential pressure acting on the closure element 20. The differential pressure then acts with respect to the entire area within the diameter D2. Due to the increased differential pressure, the tensile force is also correspondingly greater so that the holding force of the compression spring 44 is clearly overcome and the valve 10 opens as a result.

With increasing ventilation of the vacuum volume, the differential pressure decreases again. p2 approaches p1. To prevent premature resetting of the valve 10 to the closed position, the holding element. 43 (electromagnet) can be switched accordingly so that the adjusting part 20c is held in the open position by means of the holding element 43.

The valve 10 may have an internal or separately connected energy storage device that can supply energy to the shut-off component and/or the solenoid 43 so that in an emergency and in the event of a power failure, i.e., failure of the external power supply for the valve 10, opening of the valve 10 is enabled despite failure. The energy storage device holds at least the energy required to open the lifting channel 42.

FIGS. 7a and 7b show a further embodiment of a valve 10 according to the invention for ventilating a vacuum volume, in particular for the gas-tight closing and opening of a valve opening 11. FIG. 7a shows the valve 10 in a closed state (closed position), FIG. 7b in an open state (open position).

This embodiment differs from that according to FIGS. 6a and 6b by the arrangement of a further, upper holding element 45 as part of the lifting and holding unit.

The upper holding unit 45 provides the holding of the closure element 20 in the closed position. The holding force that can be effected by this holding unit 45 allows the compression spring 44 to be designed for the sole purpose of moving the closure element 20 into the closed position. In this case, the holding element 45 provides such a holding force which corresponds at least to the sum of a minimum pressing force (for pressing the seal 21 for gas-tight closure of the valve opening 11) and the force on the closure element 20 resulting from the differential pressure p1>p2.

To open the valve 10, the lifting channel 42 is released and the holding force provided by the holding element 45 is reduced or eliminated. Thereupon, the closure element 20 moves into the open position at a corresponding pressure difference (In the case of generic use for ventilating a vacuum volume) according to the principle described above.

In another embodiment (not shown), the valve 10 does not have a lifting channel 42. The valve 10 can be opened here by the sole actuation of the upper holding element 10, i.e. by a reduction or release of the holding force. For this purpose, the design of the compression spring 44 and the diameters D1 and D2 are matched accordingly.

FIGS. 8a and 8b show a further embodiment of a valve 10 according to the invention for ventilating a vacuum volume, in particular for the gas-tight closing and opening of a valve opening 11. FIG. 8a shows the valve 10 in a closed state (closed position), FIG. 8b in an open state (open position).

The valve 10 has a valve seat 30 and a closure element 20. A valve opening 11 and an opening axis A are defined by the valve seat 30. A first sealing surface 32 of the valve seat 30 surrounds the valve opening 11. The closure element 20 has a second sealing surface 22 with a sealing material 21, wherein the second sealing surface 22 corresponds to the first sealing surface 32.

The valve 10 further comprises at least one inlet opening 12 connected to the valve opening 11 by a flow path. The flow path provides for the flow of a fluid through the valve 10 in the open position, wherein a flow direction is defined by an applied differential pressure (p1 relative to p2).

The valve 10 further includes a bypass channel 28. The closure element 20 has a closure part 20a and an adjusting part 20c, wherein the closure part 20a and the adjusting part 20c are connected to each other. The adjusting part 20c limits a displaced volume 27′ inside the valve body, wherein a size of the displaced volume 27′ is variable depending on a position of the closure element 20 along the opening axis A. The adjusting part 20c thus limits the displaced volume 27 together with the housing of the valve 10. The displaced volume 27′ is sealed off from the external atmosphere by means of a seal 29.

The closure part 20a has a first vacuum side 23, with the adjusting part 20c having a second vacuum side 25′. The bypass channel 28 provides a connection of the displaced volume 27′ and a vacuum volume facing the first vacuum side 23.

The valve 10 further comprises a lifting and holding unit configured and arranged to provide a lifting force for moving and/or holding the closure element 20 to or in the closed position.

The lifting and holding unit has a lifting channel 42 that can be closed and opened by means of a shut-off component (e.g. valve), wherein the lifting channel 42 can provide a connection between the displaced volume 27′ and an external atmosphere,

The lifting and holding unit also has a negative-pressure or vacuum generator or a further vacuum volume for generating a vacuum in the displaced volume 27′. In particular, a vacuum pump or a vacuum bypass that can be shut off and opened in a controlled manner can be provided as the vacuum generator or further vacuum volume, with the vacuum bypass connecting the further vacuum volume and the displaced volume 27′. The vacuum generator can be connected to the displaced volume 27′ by a suction channel, in particular wherein the lifting channel can provide the suction channel.

The valve 10 has a check valve 48 installed in the bypass channel 28. The check valve is closed when an internal pressure (lifting pressure) present in the displaced volume 27′ is or becomes smaller than a vacuum pressure of the vacuum volume at the first vacuum side 23. The check valve is opened when the internal pressure present in the displaced volume 27 is greater than the vacuum pressure in the vacuum volume.

To move the valve 10 from the open position (FIG. 8b) ˜ i.e. from a state in which the vacuum volume is vented - to the closed position (Fig. Sa), the displaced volume 27′ is evacuated, i.e. the internal pressure in the displaced volume 27′ is reduced compared to the pressure at the first vacuum side 23. The check valve 48 is closed. This pulls the closure part 20a to the valve seat 30.

The diameters D1 and D2 are designed in such a way that the difference in the areas at a differential pressure of about. 1 bar (vacuum areas (vacuum volume and displaced volume) relative to the external atmosphere) generates a minimum compression force on the seat seal 21, e.g. 1000N.

The diameters DI and D2 are further selected (D1 >D2) so that at the same pressures in the displaced volume 27′ and at the first vacuum side 23, a contact pressure is effected and the valve remains closed.

If the pressure in the vacuum volume (at the first vacuum side 23) becomes lower than in the displaced volume 27′, the check valve 48 opens and thus ensures pressure compensation in the displaced volume 27′,

As soon as the valve 10 is in the closed position or as soon as the vacuum volume, in particular the transport tube of the vacuum conveying system, is evacuated, a possible fluid flow through the lifting channel 42 is interrupted. This can be carried out by closing the shut-off component (e.g. a shut-off valve). The flood valve 10 then remains in the closed position, i.e. the adjustment element 20 is held in the closed position.

To open the flood vaive 10 and thus to ventilate the transport tube, the shut-off component can be opened, i.e. a fluid or air can flow into the displaced volume 27. This can cause the internal pressure in the displaced volume 27′ to increase rapidly, and the closure element 20 can be moved to the open position due to the differential pressure thus created. This allows air to flow through the flow path from the inlet opening 12 to the valve opening 11 and ventilate the transport tube. In addition, air can flow into the vacuum volume via the bypass channel 28.

The closing and opening of the valve 10 can be accomplished here without the use of an active drive element, such as a motor, coupled to the adjustment element 20.

In one variant (not shown), the valve 10 may be designed without the bypass channel 28, thereby eliminating automatic pressure compensation in the displaced volume 27′.

An internal or separate energy storage device may also be available for this valve 10, through which the energy required to open the shut-off component is provided (emergency operation).

It is understood that the figures shown are only schematic illustrations of possible exemplary embodiments. According to the invention, the various approaches can also be combined with each other and with valves for closing transport systems of the prior art.

1. A valve for closing and opening a valve opening in a gas-tight manner and for ventilating a vacuum volume, for a vacuum conveying system with a transport tube for transporting an object inside along the transport tube, comprising
a valve seat having the valve opening defining an opening axis and a first sealing surface,
a closure element for substantially gas-tight closure of the valve opening, having a second sealing surface corresponding to the first sealing surface, wherein the second sealing surface is in an opposing position relative to the first sealing surface, and
an adjusting unit arranged to provide movement of the closure element relative to the valve seat such that the closure element is adjustable from an open position, in which the closure element at least partially clears the valve opening, into a closed position, in which the second sealing surface is pushed or pulled in the direction of the first sealing surface and the closure element closes the valve opening, and back again,
wherein
the valve seat, the closure element and the adjusting unit are arranged in such a way that the closure element is linearly adjustable along the opening axis, and
the valve comprises holding device arranged to hold the closure element in the closed position by providing a holding force.

2. The valve according to claim 1,
wherein
the opening axis is such that the first sealing surface faces in a direction parallel to the opening axis and the first sealing surface extends orthogonally to the opening axis.

3. The valve according to claim 1, wherein
the closure element extends in a plane orthogonally to the opening axis.

4. The valve according to claim 1, wherein
the valve comprises a coupling element and the holding device is arranged and configured to apply the holding force to the coupling element, wherein the coupling element provides a connection or coupling of the closure element with the adjusting unit.

5. The valve according to claim 1, wherein
the coupling element is designed as a valve rod, shaft or spindle and can be displaced and/or driven by means of the adjusting unit.

6. The valve according to claim 1, wherein
the holding device is designed to generate the holding force between
the closure element and the valve seat and/or
the closure element and the adjusting unit and/or
the closure element and a valve housing.

7. Valve according to claim 1, wherein
the holding device is designed as an electromechanical brake, clamping device or electromagnet, wherein the holding force can be provided in a currentless state of the holding device and can be reduced or released by energizing the holding device.

8. The valve according to claim 1, wherein
the adjusting unit is designed as a solenoid or as an electromechanical unit, in particular or as a motor, stepper motor or actuator.

9. The valve according to claim 1, wherein
the valve has an energy storage device, in particular a -battery-or an accumulator; wherein the energy storage device is set up to supply energy to the holding device and/or the adjusting unit and is connected to the holding device or the adjusting unit.

10. The valve according to claim 1, wherein
the valve has a control unit for actuating the adjusting unit and/or the holding device.

11. The valve according to claim 10, wherein
the control unit has a closing functionality set up in such a way that, when it is executed,
the closure element is moved into the closed position by means of controlled operation of the adjusting unit,
after the closed position has been reached, the closure element is held in the closed position by providing the holding force by means of the holding device, and
the actuation of the adjusting unit and/or the bolding device is terminated or the adjusting unit and/or the holding device is set to a standby mode or non-operation, wherein the holding force remains provided.

12. The valve according to claim 10, wherein
the control unit has an opening functionality set up in such a way that, when it is executed
in the closed position, the holding force is reduced or released by actuating the bolding device, wherein the closure element is displaced from the closed position in the direction of the open position by an opening force acting on the closure element, and/or
the adjusting unit is actuated in such a way that the closure element is moved into the open position.

13. The valve according to claim 1, wherein
the first and/or the second sealing surface comprises a sealing material and by contacting the sealing material through the first and the second sealing surface in the closed position, a gas-tight closure of the valve opening can be provided.

14. The valve according to claim 1, wherein
the first sealing surface surrounds the valve opening

15. The valve according to claim 1, wherein
the closure element has a closure part and a compensation part, and a bypass channelconnects the closure part and the compensation part.

16. The valve according to claim 15, wherein
the closure part has a first vacuum side and a first atmosphere side opposite to the first vacuum side,
the compensation part has a second vacuum side and a second atmosphere side opposite the second vacuum side,
the compensation part delimits a compensation volume and the size of the compensation volume is variable depending on the position of the closure element, and
a pressure present in the compensation volume is equal to a pressure present at the first vacuum side, in particular equal to a pressure present in the bypass channel.

17. The valve according to claim 16, wherein
the compensation volume is limited by a housing of the valve and the compensation part in particular the second uneuranside

18. The valve according to claim 15, wherein
a surface area of the first vacuum side is larger than a surface area of the second vacuum side.

19. The valve according to claim 15, wherein
a geometrical projection of the first vacuum side onto a plane orthogonally to the opening axis encloses a larger area than a geometrical projection of the second vacuum side onto the plane.

20. The valve according to claim 15, wherein
a diameter and/or circumference of the closure part is larger than a diameter and/or circumference of the balancingcompensation part.

21. The valve according to claim 15, wherein
the second sealing surface is arranged on the closure element, on the first atmospheric side, and the closure element has a third sealing surface arranged on the compensation part and corresponding to and cooperating with a fourth sealing surface for limiting and sealing the compensation volume.

22. The valve according to claim 15, wherein
the closure part and the compensation part are structurally firmly connected to one another, and when the closure element is moved, the closure part and the compensation part are moved simultaneously.

23. A valve for closing and opening a valve opening in a gas-tight manner and for ventilating a vacuum volume, for a vacuum conveying system having a transport tube for transporting an object inside along the transport tube, comprising
a valve seat having the valve opening defining an opening axis and a first sealing surface.
a closure element for the substantially gas-tight closure of the valve opening with a second sealing surface corresponding to the first sealing surface, wherein
the closure element is arranged to be movable along the opening axis and relative to the valve seat in such a way that the closure element is adjustable from an open position, in which the closure element at least partially clears the valve opening, into a closed position, in which the second sealing surface is pressed or pulled in the direction of the first sealing surface and the closure element closes the valve opening, and back again, and
the second sealing surface is in an opposing position relative to the first sealing surface, and
a valve housing which at least partially encloses the closure element,
wherein
the closure element has a closure part, and an adjusting part.
the closure part is designed for substantially gas-tight closure of the valve opening, and the second sealing surface is arranged on the closure part,
the adjusting part delimits a stroke volume inside the valve housing, wherein a size of the stroke volume is variable as a function of a position of the closure element along the opening axis, and
the valve has a lifting and holding unit designed and arranged to provide a lifting force for displacing and/or holding the closure element to or in the closed position.

24. The valve according to claim 23, wherein
the valve comprises a control unit for actuating the lifting and holding unit.

25. The valve according to claim 24, wherein
the control unit has a closing functionality set up in such a way that, when it is executed,
the lifting force is provided by means of actuating the lifting and holding unit,
the closure element is moved into the closed position on the basis of the lifting force.
after the closed position has been reached, the closure element is held in the closed position by actuating the lifting and holding unit, and
the actuation of the lifting and holding unit is terminated or the lifting and bolding unit is set into a standby mode or non-operation, wherein the lifting force or a holding force is provided.

26. The valve according to claim 23, wherein
the lifting and holding unit has a lifting channelthat can be closed and opened by means of a shut-off component, wherein the lifting channel provides a connection between the stroke volume and an external atmosphere.

27. The valve according to claim 23, wherein
the lifting and holding unit comprises a first holding element, wherein the first holding element is designed and arranged to hold the closure element in the closed position.

28. The valve according to claim 23, wherein
characterized in that the lifting and holding unit comprises a second bolding element, wherein the second holding element is designed and arranged to hold the closure element in the open position.

29. The valve according to claim 23, wherein
the lifting and holding unit has a restoring element.

30. The valve according to claim 23, wherein
the lifting and holding unit has a vacuum generator for generating a vacuum in the stroke volume or is connected to a vacuum generator, in particular wherein the vacuum generator is a vacuum pump or has a vacuum bypass which can be shut off and opened in a controlled manner and connects the vacuum volume and the stroke volume.

31. The valve according to claim 30, wherein
the vacuum generator is connected to the stroke volume by a suction channel, in particular wherein the lifting channel provides or embodies the suction channel.

32. The valve according to claim 23, wherein
the valve comprises a bypass channel, wherein the bypass channel provides a connection of the stroke volume and the vacuum volume

33. The valve according to claim 32, wherein
the bypass channel comprises a check valve, which check valve
is closed when a lifting pressure present in the stroke volume is less than a vacuum pressure in the vacuum volume, and
is open when a lifting pressure present in the stroke volume is greater than a vacuum pressure in the vacuum volume.

34. The valve according to claim 23, wherein
the closure part has a first vacuum side and the adjusting part has a second vacuum side bounding the stroke volume and facing the stroke volume.

35. The valve according to claim 34, wherein
a surface area of the first vacuum side is smaller than a surface area of the second vacuum side.

36. The valveaccording to claim 34, wherein
a geometric projection of the first vacuum side onto a plane orthogonally to the opening axis encloses a smaller area than a geometric projection of the second vacuum side onto the plane.

37. The valve according to claim 23, wherein
a diameter and/or circumference of the closure part is smaller than a diameter and/or circumference of the adjusting part.

38. The valve according to claim 23, wherein
the closure part and the adjusting part are structurally firmly connected to one another, designed integrally, and the closure part and the adjusting part are moved simultaneously when the closure element is moved.

39. A vacuum Vacuure conveying system having
a transport tube for transporting an object inside along the transport tube. wherein a negative pressure, can be provided inside the transport tube relative to the surrounding atmosphere, and
a valve integrated into the vacuum conveying system and/or connected to the transport tube according to claim 1, wherein
the valve seat is integrated into, connected to and/or arranged on a wall of the transport tube in such a way that, in the open position of the valve, the valve opening opens up a flow path between the interior of the transport tube and the surrounding atmosphere.

40. The vacuum conveying system according to claim 39, wherein
the object is a transport means, wherein the transport means is designed for transporting a person and/or goods.

41. The vacuum conveying system according to claim 39, wherein
the first sealing surface faces the interior of the transport tube and/or
the valve seat and/or the first sealing surface is present within the interior of the transport tube.
